(19) United States
(12) Patent Application Publication
(10) Pub. No.: US 2014/0358749 A1
(43) Pub. Date: Dec. 4, 2014

(54) Cross-Reference Electric Vehicle Charge Data for Billing

(71) Applicant: General Motors LLC, Detroit, MI (US)

(72) Inventors: Nate Williams, Ann Arbor, MI (US); Venkatesh Donthy, Novi, MI (US); Paul H. Pebbles, Novi, MI (US)

(21) Appl. No.: 13/904,175

(22) Filed: May 29, 2013

(51) Int. Cl. G06Q 30/04; G06Q 50/06

(52) U.S. Cl. CPC G06Q 30/04; G06Q 50/06
USPC 705/34

(57) ABSTRACT

Implementations of the present invention contemplate using the communicative connections between a telematics unit in a vehicle and a telematics service provider (TSP) to transmit information pertaining to a vehicle charging event from the vehicle to the TSP. Implementations further contemplate comparing such with information independently furnished to the TSP by a charge station or a communication service associated with a charge station. The present invention facilitates the charging of electric vehicles at charging stations by reducing the inconvenience associated with paying for the electrical power obtained from the charging station. By transferring the billing functions to a TSP, implementations of the present invention also enable charging stations to do away with equipment required for billing customers at the point of sale and thereby limit the costs of building such charging stations.

### TECHNOLOGY FIELD

The present disclosure relates generally to vehicular telematics systems and more specifically to the use of telematics units within electric vehicles to transmit charging data to a service provider where it can be cross referenced with additional data for billing purposes.

### BACKGROUND

Consumer demand for electric vehicles has increased in recent years and may continue to increase in the future. Growing consumer demand for electric vehicles has been propelled by increasing fossil fuel prices and the resulting increase in the operational costs of internal combustion vehicles. Simultaneously, consumer demand for electric vehicles has been further propelled by concerns that the combustion of fossil fuels causes environmental degradation. Environmental concerns have engendered legislation designed to reduce the costs of “clean” technologies relative to alternative technologies that are associated with pollution. For example, tax incentives and government rebates have been provided to purchasers of electric vehicles. Nevertheless, the limited range of electric vehicles can be an inconvenience to many drivers and limit the viability of electric vehicles for consumers who desire the ability to travel long distances without significant delays caused by recharging and by locating and traveling to recharging stations.

The construction of an infrastructure of electric vehicle charging stations is necessary to increase the effective range and utility of electric vehicles. Increasing the range and utility of electric vehicles by expanding the infrastructure of charging stations will increase consumer demand for electric vehicles. Furthermore, the expansion of the electric vehicle charging infrastructure will create opportunities for utility companies that supply electricity to increase their electricity sales. As larger numbers of consumers transition from driving internal combustion vehicles to driving electric vehicles, sales of electricity used to power electric vehicles will experience a corresponding increase. Furthermore, the establishment and maintenance of facilities for charging electronic vehicles will similarly become a more profitable business endeavor.

### SUMMARY OF THE INVENTION

Implementations of the present invention contemplate using the communicative connections between a telematics unit in a vehicle and a telematics service provider (TSP) to transmit information pertaining to a vehicle charging event from the vehicle to the TSP. Thereafter, the information transmitted by the telematics unit can be compared with information independently furnished to the TSP by a charge station or a communication service associated with a charge station. A comparison of information pertaining to a charging event furnished by two different sources enables the TSP to verify that customer billing for charging events is accurate. Some implementations contemplate the transmission of charging event information to the TSP from the telematics unit and from the charging station in real time. In such implementations, it can be determined, in real time, whether a vehicle is appropriately registered with the charging station during the charging event. Implementations of the present invention facilitate the charging of electric vehicles at charging stations by reducing the inconvenience associated with paying for the electrical power obtained from the charging station. By transferring the billing functions to a TSP, implementations of the present invention also enable charging stations to do away with equipment required for billing customers at the point of sale and thereby limit the costs of building such charging stations.

One implementation consists of a method, implemented by a telematics service provider (TSP), for billing a subscriber of the TSP for electrical power received by a plug-in electric vehicle (PEV) during a charging event at a charging station, the method comprising receiving, at a computer readable medium, data pertaining to the charging event sent from a telematics unit of the PEV, receiving data generated by the charging station and pertaining to the charging event, determining that the data received from the telematics unit matches the data generated by the charging station, and authorizing billing of the subscriber for the electrical power received during the charging event.

An additional implementation consists of a non-transient computer readable medium having stored thereon a set of computer executable instructions for billing a subscriber of a telematics service provider (TSP) for electrical power received by a plug-in electric vehicle (PEV) during a charging event at a charging station, the set of instructions comprising instructions for receiving, from a telematics unit of the PEV, data pertaining to the charging event, receiving data generated by the charging station and pertaining to the charging event, determining that the data received from the telematics unit matches the data generated by the charging station, and authorizing billing of the subscriber for the electrical power received during the charging event.

A further implementation consists of a system for billing a subscriber of a telematics service provider (TSP) for electrical power received by a plug-in electric vehicle (PEV) during a charging event at a charging station, the system comprising a server configured to receive, from a telematics unit of the PEV, data pertaining to the charging event, to receive, data generated by the charging station and pertaining to the charging event, to determine that the data received from the telematics unit matches the data generated by the charging station, and to authorize billing of the subscriber for the electrical power received during the charging event, and the telematics unit, wherein the telematics unit is configured to transmit data pertaining to the charging event to the TSP.

### BRIEF DESCRIPTION OF THE DRAWINGS

While the appended claims set forth the features of the present invention with particularity, the invention, together with its objects and advantages, may be best understood from the following detailed description taken in conjunction with the accompanying drawings of which:

FIG. 1 is a schematic diagram of an operating environment for a mobile vehicle communication system usable in implementations of the described principles;

FIG. 2 is a schematic diagram of an operating environment for the charging of an electric vehicle and for the transmission of information pertaining to the charging to a telematics service provider (TSP) from both a telematics unit of the vehicle and the charging station where the electric vehicle is charged;

FIG. 3 is a flow chart summarizing an example process executed by a telematics service provider for identifying unauthorized charging of an electric vehicle.

FIG. 4 is a flow chart summarizing an example process executed by a telematics service provider for billing an electric vehicle for the electrical power acquired during a charging event at a charging station; and

FIG. 5 is a flow chart summarizing an example process executed by a telematics unit for providing information pertaining to a charging event of an electric vehicle to a telematics service provider.

### DETAILED DESCRIPTION OF THE DRAWINGS

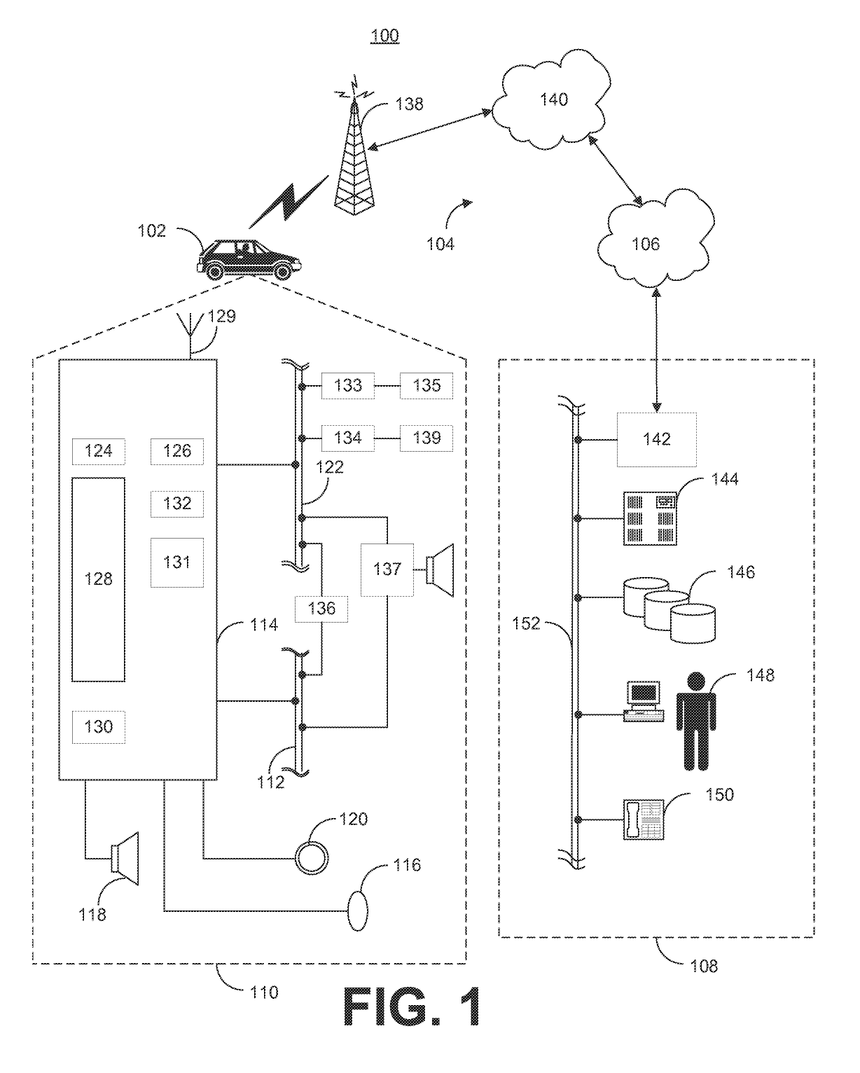

Before discussing the details of the invention, a brief overview of an example telematics system is given to guide the reader. FIG. 1 schematically depicts an example environment for carrying out the invention. It will be appreciated that the described environment is an example, and does not imply any limitation regarding the use of other environments to practice the invention. With reference to FIG. 1 there is shown an example of a communication system 100 that may be used with the present systems and methods and generally includes a vehicle 102, a wireless carrier system 104, a land network 106 and a call center 108. It should be appreciated that the overall architecture, setup and operation, as well as the individual components of a system such as that shown in FIG. 1 are generally known in the art. Thus, the following paragraphs provide a brief overview of one such example information system 100. However, present systems and methods could be carried out in other environments as well.

Vehicle 102 is a mobile vehicle such as a motorcycle, car, truck, recreational vehicle (RV), boat, plane, etc., and is equipped with suitable hardware and software that enables it to communicate over system 100. The vehicle 102 is, in particular, driven by an electric motor that periodically requires recharging. Additionally, vehicle hardware 110 shown generally in FIG. 1 includes: a telematics unit 114, a microphone 116, a speaker 118, and buttons and/or controls 120 connected to the telematics unit 114. A network connection or vehicle bus 122 is operatively coupled to the telematics unit 114. Examples of suitable network connections include a controller area network (CAN), a media oriented system transfer (MOST), a local interconnection network (LIN), an Ethernet, and other appropriate connections such as those that conform with known ISO, SAE, and IEEE standards and specifications, to name but a few.

The telematics unit 114 is an onboard device providing a variety of services through its communication with the call center 108, and generally includes an electronic processing device 128, one or more types of electronic memory 130, a cellular chipset/component 124, a wireless modem 126, a dual antenna 129 and a navigation unit containing a GPS chipset/component 132. The GPS chipset/component is capable of determining the location of the vehicle with a high degree of accuracy. For example, the GPS chipset/component could determine that an electric vehicle is located at a particular electric vehicle charging station. In one example, the wireless modem 126 comprises, and is carried out in the form of, a computer program and/or set of software routines executing within the electronic processing device 128. The cellular chipset/component 124 and the wireless modem 126 may be called the network access device (NAD) of the telematics unit 114. The NAD 114 further includes a short-range wireless unit 131 capable of communicating with a user's mobile device such as a cellular phone, tablet computer, PDA, or the like, over a short-range wireless protocol. For example, in one implementation, the short-range wireless unit 131 is a Bluetooth unit with an RF transceiver that communicates with a user's mobile device using Bluetooth protocol.

The telematics unit 114 provides a variety of services for subscribers. Examples of such services include: turn-by-turn directions and other navigation-related services provided in conjunction with the GPS based chipset/component 132; airbag deployment notification and other emergency or roadside assistance-related services provided in connection with various crash and or collision sensor interface modules 133 and sensors 135 located throughout the vehicle.

GPS navigation services are implemented based on the geographic position information of the vehicle provided by the GPS based chipset/component 132. A user of the telematics unit enters a destination using inputs corresponding to the GPS component, and a route to a destination is calculated based on the destination address and a current position of the vehicle determined at approximately the time of route calculation. Turn-by-turn (TBT) directions may further be provided on a display screen corresponding to the GPS component and/or through vocal directions provided through a vehicle audio component 137. It will be appreciated that the calculation-related processing may occur at the telematics unit or may occur at a call center 108.

Infotainment-related services are provided by the TSP wherein music, Web pages, movies, television programs, video games and/or other content is downloaded to an infotainment center 136 operatively connected to the telematics unit 114 via a vehicle bus 122 and an audio bus 112. In one example, downloaded content is stored for current or later playback.

The preceding list of functions is by no means an exhaustive list of all of the capabilities of telematics unit 114, as should be appreciated by those skilled in the art, but is simply an illustration of some of the services that the telematics unit 114 offers. The telematics unit 114 may include a number of components known by those skilled in the art in addition to those described above.

Vehicle communications use radio transmissions to establish a communications channel within the wireless carrier system 104 so that voice and/or data transmissions occur over the communications channel. Vehicle communications are enabled via the cellular chipset/component 124 for voice communications and a wireless modem 126 for data transmission. For example, data pertaining to a forecast of a utility's renewable energy mixture can be transmitted to the telematics unit 114 via the wireless modem 126.

To enable successful data transmission over the communications channel, wireless modem 126 applies some form of encoding or modulation to convert the digital data so that it can communicate through a vocoder or speech codec incorporated in the cellular chipset/component 124. Any suitable encoding or modulation technique that provides an acceptable data rate and bit error can be used with the present method. The dual mode antenna 129 services the GPS chipset/component and the cellular chipset/component.

The microphone 116 provides the driver or other vehicle occupant with a means for inputting verbal or other auditory commands, and can be equipped with an embedded voice processing unit utilizing a human/machine interface (HMI) technology known in the art. Conversely, the speaker 118 provides verbal output to the vehicle occupants and can be either a stand-alone speaker specifically dedicated for use with the telematics unit 114 or can be part of the vehicle audio component 137. In either event, the microphone 116 and the speaker 118 enable vehicle hardware 110 and the call center 108 to communicate with the occupants through audible speech.

The vehicle hardware also includes the one or more buttons or controls 120 configured to enable a vehicle occupant to activate or engage one or more of the vehicle hardware components 110. For example, one of the buttons 120 is an electronic push button that, when pressed, initiates voice communication with the call center 108 (whether it be a live advisor 148 or an automated call response system). In another example, one of the buttons 120, when pushed, initiates emergency services.

The audio component 137 is operatively connected to the vehicle bus 122 and the audio bus 112. The audio component 137 receives analog information, rendering it as sound, via the audio bus 112. Digital information is received via the vehicle bus 122. The audio component 137 provides AM and FM radio, CD, DVD, and multimedia functionality independent of the infotainment center 136. The audio component 137 contains a speaker system, or alternatively utilizes the speaker 118 via arbitration on the vehicle bus 122 and/or the audio bus 112.

The vehicle crash and/or collision detection sensor interface 133 is operatively connected to the vehicle bus 122. The crash sensors 135 provide information to the telematics unit 114 via the crash and/or collision detection sensor interface 133 regarding the severity of a vehicle collision, such as the angle of impact and the amount of force sustained.

Vehicle sensors 139, connected to various sensor interface modules 134 are operatively connected to the vehicle bus 122. Vehicle sensors 139 include sensors with capabilities that include but that are not limited to determining a battery's state of charge (e.g. as a percentage of the total charge capacity), the charging status of a battery (i.e. whether the battery is currently being charged), and the current rate at which the battery is being charged (e.g. as a rate of change of the percentage of capacity charged per unit time). The vehicle sensors 139 can also include but are not limited to gyroscopes, accelerometers, magnetometers, emission detection and/or control sensors, and the like. The sensor interface modules 134 can include power train control, climate control, and body control, to name but a few.

The wireless carrier system 104 can be a cellular telephone system or any other suitable wireless system that transmits signals between the vehicle hardware 110 and the land network 106. According to an example, the wireless carrier system 104 includes one or more cell towers 138, base stations and/or mobile switching centers (MSCs) 140, as well as any other networking components required to connect the wireless system 104 with the land network 106. The mobile switching center may include a remote data server.

As appreciated by those skilled in the art, various cell tower/base station/MSC arrangements are possible and could be used with the wireless system 104 (also referred to as the “cellular network” herein). For example, a base station and a cell tower could be co-located at the same site or they could be remotely located, a single base station could be coupled to various cell towers, and various base stations could be coupled with a single MSC, to name but a few of the possible arrangements. Preferably, a speech codec or vocoder is incorporated in one or more of the base stations, but depending on the particular architecture of the wireless network, it could be incorporated within a Mobile Switching Center or some other network component as well.

The land network 106 is, for example, a conventional land-based telecommunications network connected to one or more landline telephones and connecting wireless carrier network 104 to call center 108. For example, the land network 106 includes a public switched telephone network (PSTN) and/or an Internet protocol (IP) network, as is appreciated by those skilled in the art. Of course, one or more segments of the land network 106 are implemented in the form of a standard wired network, a fiber or other optical network, a cable network, other wireless networks such as wireless local networks (WLANs) or networks providing broadband wireless access (BWA), or any combination thereof.

The call Center (OCC) 108 is designed to provide the vehicle hardware 110 with a number of different system back-end functions and, according to the example shown here, generally includes one or more switches 142, servers 144, databases 146, live advisors 148, and a variety of other telecommunication and computer equipment 150 that is known to those skilled in the art. These various call center components are coupled to one another, for example, via a network connection or bus 152, such as the one previously described in connection with the vehicle hardware 110. Switch 142, which can be a private branch exchange (PBX) switch, routes incoming signals so that voice transmissions are usually sent to either the live advisor 148 or an automated response system, and data transmissions are passed on to a modem or other piece of telecommunication and computer equipment 150 for demodulation and further signal processing.

The telecommunication and computer equipment 150 includes a modem that preferably includes an encoder, as previously explained, and can be connected to various devices such as application servers 144 and databases 146. For example, the databases 146 could be designed to store subscriber profile records, subscriber behavioral patterns, or any other pertinent subscriber information. Although the illustrated example has been described as it would be used in conjunction with a manned call center, it will be appreciated that the call center 108 can be any central or remote facility, manned or unmanned, mobile or fixed, to or from which it is desirable to exchange voice and data.

A portion of the databases 146 stores information pertaining to the identity of the telematics unit 114. For example, the databases 146 may store, for each vehicle enrolled in a program, an integrated circuit card identifier (ICCID) corresponding to the subscriber identity modules (SIMs) of the vehicle's telematics unit, an international mobile equipment identity (IMEI) corresponding to network access devices (NADs) integrated into the vehicle's telematics units, a mobile identification number (MIN), an electronic serial numbers (ESN), a mobile equipment identifier (MEID), an international mobile subscriber identity (IMSI) associated with the SIM cards of the vehicle's telematics unit, a mobile device number (MDN), a mobile station international subscriber directory number (MSISDN), a service set identifier (SSID), a media access control (MAC) address, and an internet protocol (IP) address associated with the vehicle's telematics unit. Additional information pertaining to a subscriber affiliated with a particular telematics unit 114 may also be stored in the databases 146. For example, billing information associated with the subscriber may be stored in the databases 146. The preceding examples of information that can be stored at databases 146 is not exhaustive, and additional fields of data may also be stored at databases 146.

The servers 144 interface with utility companies that supply electricity (not shown), databases 146, and telematics units such as the telematics unit 114. The servers 144 have processors that can be configured to request and receive information from telematics units such as the telematics unit 114. In some implementations, information requested and received by the servers 144 is subsequently stored in the databases 146. Furthermore, the servers 144 may communicate with the utility companies that supply electricity (not shown) through a land network, such as land network 106, through a wireless carrier system, such as e.g., wireless carrier system 104, or through a combination of a land network and a wireless carrier system. The servers 144 may request information from the electrical utilities, receive information from the electrical utilities, and store information received from the electrical utilities. In some implementations, the information received from the electrical utilities is stored at databases 146.

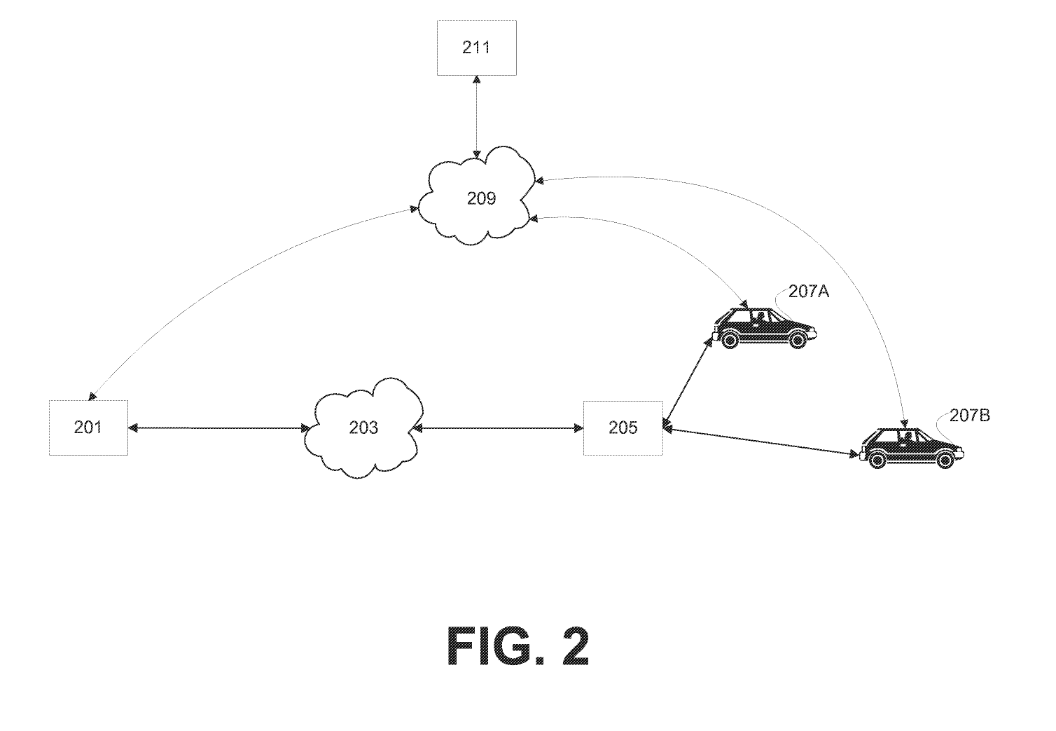

FIG. 2 is a schematic diagram of an operating environment for the charging of an electric vehicle and for the transmission of information pertaining to the charging to a telematics service provider (TSP) from both a telematics unit of the vehicle and the charging station where the electric vehicle is charged. An electrical power utility operations control center (EPUOCC) 201 is connected to a utility communications network 203. The EPUOCC 201 may receive, store, analyze, and process a variety of information pertaining to operations of the electrical power utility. Utility communications network 203 transmits information to and from the EPUOCC 201. A charging station 205 includes one or more plugs where an electric vehicle can obtain electrical power necessary to charge its batteries. The charging station 205 may be a controlled parking space where only certain vehicles are permitted entry. In some implementations, the charging station 205 only permits certain vehicles to charge. Electric vehicles 207A and 207B receive electrical power from the charging station 205 during charging events. Multiple electric vehicles may charge simultaneously at the same charging station by using different plugs. The electric vehicles 207A and 207B are equipped with telematics units, such as telematics unit 114 of FIG. 1, which enable communication with a telematics service provider (TSP) 211 through a network 209. The network 209 may comprise one or more of the following: a wireless network, a wired network, and/or a combination of wireless and wired networks.

In general terms, not intended to limit the claims, the example environment depicted by FIGS. 1 and 2 may be used by systems and methods that transmit information, which pertains to a charging event of an electric vehicle and which is acquired or ascertained by both the electric vehicle and a charging station at which the charging event occurs, to a telematics service provider (TSP). Implementations of the methods and systems described herein contemplate billing users and/or owners of electric vehicles who subscribe to the services provided by a TSP and also charge their vehicles at charging stations. In some implementations, access to the charging stations are restricted. For example, access to the charging stations may be limited to only those electric vehicle owners and/or users who register to use the charging stations. Registration may involve the payment of a monthly fee or the payment of a per usage fee. In some implementations, a per usage charge may be accompanied by a periodic registration fee. For example, access to the charging stations may require that an annual fee be paid and further require a per usage payment. In other implementations, the periodic fee allows the user to acquire up to a threshold amount of electrical power from the charging stations, and the user/owner of the electric vehicle is required to make additional payments in order to acquire additional electrical power. In some implementations, the fees paid by users may grant the users access to a single charging station, while in other implementations the fees paid by users may grant them access to a network of multiple charging stations.

Regardless of the structure of fees and payments required of users by charging stations, the systems and methods of the present invention enable subscribers of a TSP to tender payment to the charging stations through the TSP. In that manner, the present invention eliminates the need for subscribers to pay for the electrical power acquired from the charging stations at the point of acquisition, i.e. at the physical location of the charging station. The present invention thereby facilitates authorized and tracked acquisition and purchase of electrical power from an electric vehicle charging station. The present disclosure provides a means by which the amount of electrical power received by the vehicle and the price charged for the electrical power acquired by the vehicle can be verified by data provided from two independent sources. In particular, the present disclosure contemplates transferring charge event information to the TSP by both the telematics unit in the vehicle being charged and by the charging station itself. The receipt of different information from the telematics unit and the charging station can thereby trigger identification of equipment malfunctions at either the charging station or the vehicle.

Upon receipt of information by the TSP from the telematics unit in a vehicle being charged and from a charging station where the vehicle is being charged, some implementations of the systems and methods described in the present disclosure verify that the amount of electrical power received by the vehicle as reported by each source match. In the event that the reported amounts of electrical power domatch, the TSP authorizes a subscriber account corresponding to the electric vehicle to be charged a particular amount. In other implementations, the TSP authorizes an account associated with the subscriber account to make a payment to the charging station or to a payment agent associated with the charging station. In some implementations the subscriber account may have a certain quantity of funds previously set aside to cover the costs associated with vehicle charging events. In such implementations the funds set aside to cover vehicle charging events may be identified as a prepaid account for vehicle charging. The accounts charged by the TSP or the accounts from which the TSP authorizes payments to be made may be maintained by the TSP or by an entity external to the TSP.

In addition to authorizing, approving, and making payments for electrical power received during vehicle charging events, some implementations of the systems and methods contemplated by the present invention can verify whether or not a vehicle charging at a particular charging station is registered or otherwise authorized to draw power from the charging station. In such implementations, upon receiving information pertaining to the charging event from the telematics unit in the vehicle and from the charging station, the TSP determines whether or not the vehicle is authorized to charge at the particular charging station. If the vehicle is not authorized or registered, the TSP may notify the charging station that the vehicle is not authorized to charge and thereby facilitate an enforcement action. For example, the TSP may assess a charge to a subscriber account if it is determined that the vehicle is not permitted to charge from the charging station. In other implementations, the TSP may notify an enforcement entity and the enforcement entity may make an enforcement action against the subscriber associated with the vehicle. For example, the TSP may notify the charging station or an entity associated with the charging station and the vehicle may be ticketed. In other implementations, upon a determination that the vehicle is not registered with the charging station, the TSP may facilitate the registration of the vehicle. In such implementations, the TSP may communicate with the telematics unit in the vehicle and provide a user of the vehicle with the opportunity to register with the charging station through the vehicle's user interfaces.

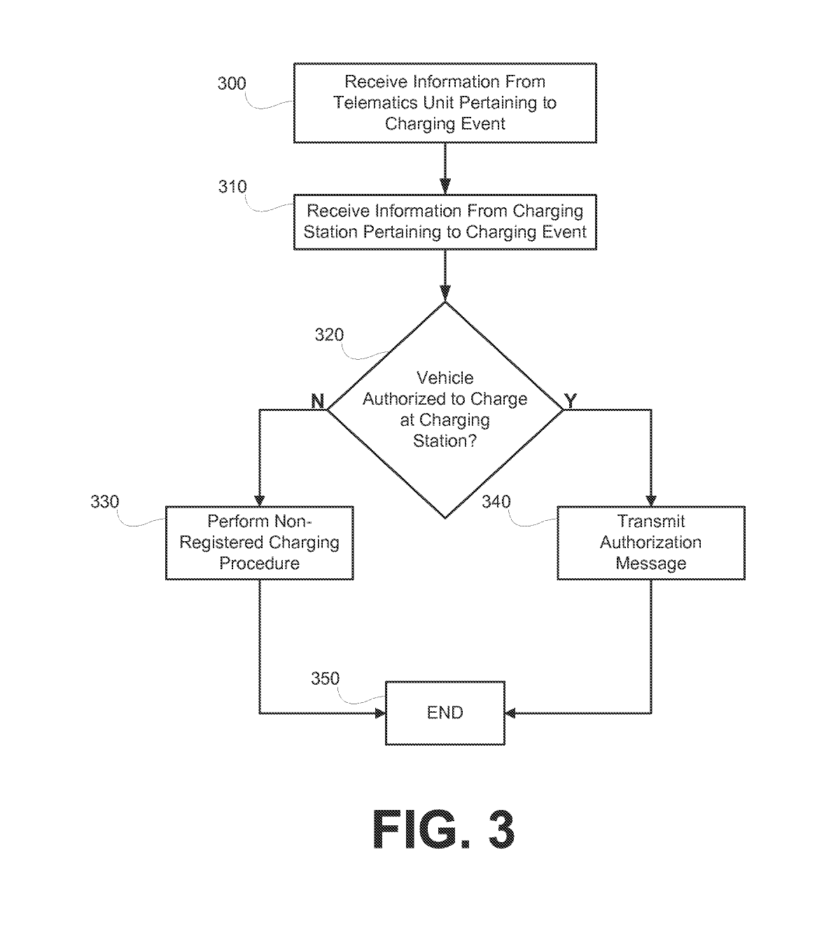

FIG. 3 is a flow chart summarizing an example process executed by a telematics service provider (TSP) for identifying unauthorized charging of an electric vehicle. At step 300, the TSP receives information from telematics unit 114 of electric vehicle 102 that is about to begin, is currently undergoing, or that has recently undergone a charging event. The information received from the telematics unit 114 includes information pertaining to the charging event. The information received from the telematics unit 114 may vary depending upon whether the charging event has not yet begun, is currently in progress, or has recently concluded. The information pertaining to the charging event may include but is not limited to the time at which the charging event began, the time at which the charging event ended, the amount of electrical power acquired during the charging event (e.g. in kWh), the price of the electrical power obtained by the vehicle during the charging event (e.g. in dollars/kWh), the total price of the electrical power obtained by the vehicle during the charging event (e.g. in dollars), the geographic location at which the charging station associated with the charging event is located (e.g. as GPS coordinates), and charging station registration information. Charging station registration information may include a list of charging stations at which the vehicle is registered to charge. In some implementations, the list of charging stations at which the vehicle is registered to charge is stored at databases 146. The information received from the telematics unit 114 at step 300 also includes information pertaining to the vehicle 102 and/or the telematics unit 114. The information pertaining to the vehicle 102 and telematics unit 114 may include but is not limited to a vehicle identification number (VIN), an integrated circuit card identifier (ICCID) corresponding to the subscriber identity module (SIM) of the telematics unit 114, an international mobile equipment identity (IMEI) corresponding to a network access device (NAD) integrated into the telematics unit 114, a mobile identification number (MIN), an electronic serial number (ESN), a mobile equipment identifier (MEID), an international mobile subscriber identity (IMSI) associated with the SIM card of the telematics unit 114, a mobile device number (MDN), a mobile station international subscriber directory number (MSISDN), a service set identifier (SSID), a media access control (MAC) address associated with the telematics unit 114, and an internet protocol (IP) address associated with the telematics unit 114.

If the charging event has not yet begun, the information received from the telematics unit 114 at step 300 may include but is not limited to the time at which the vehicle become connected to the charging outlet, a total amount of electrical power the vehicle requests to obtain from the charging event (e.g. in kWh), a total price of electrical power the vehicle requests to obtain during the charging event (e.g. in dollars), the price of the electrical power the vehicle requests to obtain during the charging event (e.g. in dollars/kWh), the geographic location of the charging station at which the vehicle requests charge from, and an identifier for the charging station that the vehicle is connected to.

At step 310, the TSP receives information from the charging station pertaining to a charging event involving vehicle 102. The information pertaining to the charging event received by the TSP at step 310 may include but is not limited to the time at which the charging event began, the time at which the charging event ended, the amount of electrical power acquired during the charging event (e.g. in kWh), the price of the electrical power obtained by the vehicle during the charging event (e.g. in dollars/kWh), the total price of the electrical power obtained by the vehicle during the charging event (e.g. in dollars), the geographic location at which the charging event took place (e.g. as GPS coordinates), and an identifier for the charging station at which the charging event took place. The identifier for the charging station at which the charging event is about to take place, is taking place, or took place may be a name of the charging station, a charging station identification number, a identification number indicating an owner of the charging station and an additional identification number assigned by the owner, and an identification number assigned by the TSP.

If the charging event has not yet begun, the information received from the charging station at step 310 may include but is not limited to the time at which the vehicle become connected to the charging outlet, a total amount of electrical power the vehicle requests to obtain from the charging event (e.g. in kWh), a total price of electrical power the vehicle requests to obtain during the charging event (e.g. in dollars), the price of the electrical power the vehicle requests to obtain during the charging event (e.g. in dollars/kWh), the geographic location of the charging station at which the vehicle requests charge from, and an identifier for the charging station that the vehicle is connected to.

At step 320, the TSP determines whether or not the vehicle 102 is authorized to charge at the charging station. Determining whether or not the vehicle 102 is authorized to charge may involve determining an identity of the charging station, determining a list of identities for each of the charging stations at which the vehicle is permitted to charge, and determining if the identity of the charging station is included in the list of identities at which the vehicle is permitted to charge. In some implementations, determining whether or not the vehicle 102 is authorized to charge at the charging station also includes determining whether or not the charging station is open to any vehicle or whether charging at the charging station is restricted to vehicles that have registered at the charging station.

If it is determined at step 320 that the vehicle 102 is permitted to charge at the charging station, the process proceeds to step 340 where a charging authorization message is transmitted. The charging authorization message may be transmitted to the telematics unit 114, to the charging station, or to both the telematics unit 114 and the charging station. In some implementations, the charging authorization message may be transmitted to an entity that relays the message to the charging station or to the telematics unit 114. Thereafter the process proceeds to step 350 where the process ends.

On the other hand, if it is determined at step 320 that the vehicle 102 is not permitted to charge at the charging station, the process proceeds to step 330. At step 330, the TSP performs a non-registered charging procedure. In some implementations, the non-registration procedure involves notifying the charging station that the vehicle is not authorized to charge and thereby facilitates an enforcement action. In implementations where the vehicle has already begun charging, the notification that the vehicle is not authorized to charge can be sent in real time, i.e. while the vehicle is still charging. In implementations where the charging event has not yet begun, the non-registration procedure may involve transmitting a message indicating that the vehicle is not authorized to charge at the charging station. In such implementations, the transmission of such a not authorized message may trigger a locking of the charging station or a particular outlet at the charging station thereby preventing the electric vehicle from obtaining charge from the charging station.

The non-registered charging procedure performed at step 330 involves facilitating the registration of the vehicle in some implementations. Registration may be facilitated in implementations where the vehicle has not yet begun to draw charge from the charging station, in implementations where the vehicle is presently drawing charge from the charging station, and in implementations where the vehicle has completed drawing charge from the charging station. Facilitating registration of the vehicle may involve transmitting instructions to the vehicle to display a prompt to a user of the vehicle that requests input from the user pertaining to whether or not the user is interested in registering with the charging station. Facilitating registration of the vehicle may further involve but is not limited to receiving input from the user indicating the desire of the user to register the vehicle with the charging station and authorizing payment necessary for charging registration. Authorizing payment for charging registration may involve but is not limited to transferring funds from an account linked to the telematics unit 114 or to the vehicle 102 to the charging station or to an entity associated with the charging station, assessing a charge to a subscriber account, transmitting a message to an institution that manages an account associated with the subscriber, and transmitting credit card information associated with the subscriber to the charging station or an entity associated with the charging station. One of ordinary skill in the art will understand that there are numerous other ways of authorizing payment for the charging station registration that are not specifically enumerated herein that may nevertheless be performed by implementations of the invention described herein. Thereafter, the process proceeds to step 350, where the process ends.

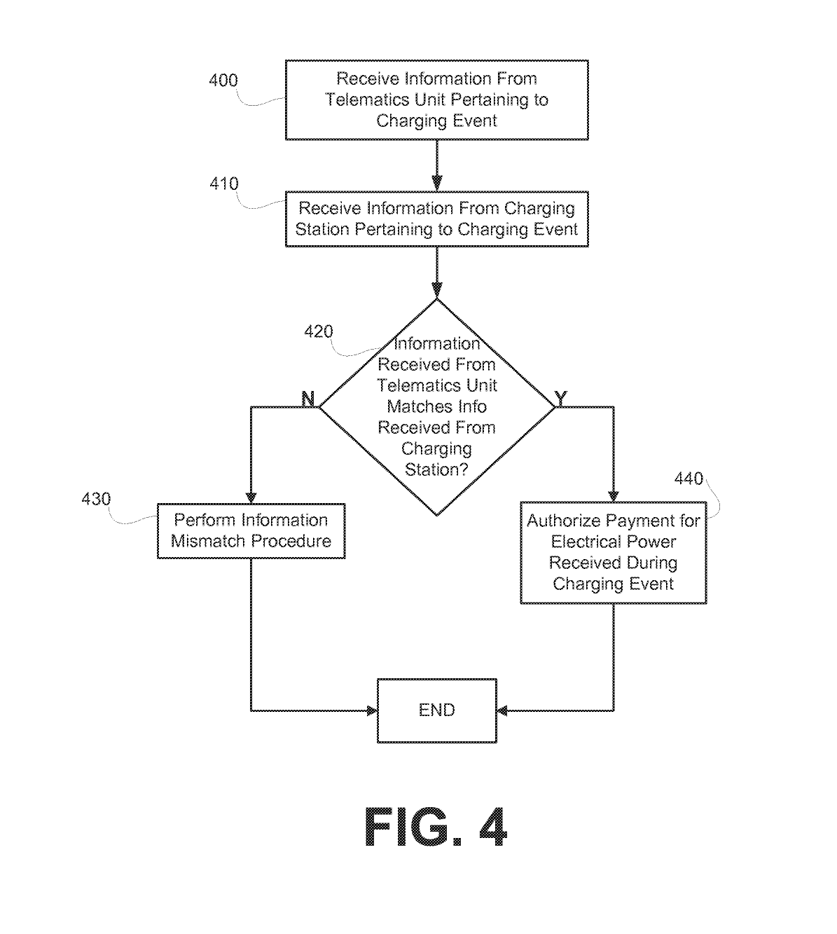

Turning now to FIG. 4, a flow chart summarizing an example process executed at a telematics service provider (TSP) for billing an electric vehicle for the electrical power acquired during a charging event at a charging station is depicted. At step 400, the TSP receives information from telematics unit 114 of electric vehicle 102 that is currently undergoing or that has recently undergone a charging event. The information received from the telematics unit 114 includes information pertaining to the charging event. The information pertaining to the charging event may include but is not limited to the time at which the charging event began, the time at which the charging event ended, the amount of electrical power acquired during the charging event (e.g. in kWh), the price of the electrical power obtained by the vehicle during the charging event (e.g. in dollars/kWh), the total price of the electrical power obtained by the vehicle during the charging event (e.g. in dollars), and the geographic location at which the charging event took place (e.g. as GPS coordinates). The information received from the telematics unit 114 at step 400 also includes information pertaining to the vehicle 102 and/or the telematics unit 114. The information pertaining to the vehicle 102 and telematics unit 114 may include but is not limited to a vehicle identification number (VIN), an integrated circuit card identifier (ICCID) corresponding to the subscriber identity module (SIM) of the telematics unit 114, an international mobile equipment identity (IMEI) corresponding to a network access device (NAD) integrated into the telematics unit 114, a mobile identification number (MIN), an electronic serial number (ESN), a mobile equipment identifier (MEID), an international mobile subscriber identity (IMSI) associated with the SIM card of the telematics unit 114, a mobile device number (MDN), a mobile station international subscriber directory number (MSISDN), a service set identifier (SSID), a media access control (MAC) address associated with the telematics unit 114, and an internet protocol (IP) address associated with the telematics unit 114.

At step 410, the TSP receives information from the charging station pertaining to a charging event involving vehicle 102. The information pertaining to the charging event received by the TSP at step 410 may include but is not limited to the time at which the charging event began, the time at which the charging event ended, the amount of electrical power acquired during the charging event (e.g. in kWh), the price of the electrical power obtained by the vehicle during the charging event (e.g. in dollars/kWh), the total price of the electrical power obtained by the vehicle during the charging event (e.g. in dollars), the geographic location at which the charging event took place (e.g. as GPS coordinates), and an identifier for the charging station at which the charging event took place. The identifier for the charging station at which the charging event took place may be a name of the charging station, a charging station identification number, and an identification number indicating an owner of the charging station and an additional identification number assigned by the owner.

At step 420, the TSP determines whether or not the data pertaining to the charging event received at step 400 matches the data pertaining to the charging event received at step 410. In some implementations, determining whether the data received at step 400 matches the data received at step 410 involves determining values contained in discrete data fields from each set of data, determining which discrete data fields are found in both data sets (i.e. “overlapping data fields”), and determining whether the values in the corresponding discrete data fields found in both data sets are the same. In some implementations, values in the corresponding discrete data fields need not be exact matches in order to be considered to be matching. For example, data values that are within a predetermined numerical range of each other may be considered to be matching. Alternatively, data values that vary by a predetermined percentage of one of the values, or by the mean of the values, may be considered to be matching. In some implementations, certain discrete data fields must be found in both the information received at step 400 and the information received at step 410 in order for the data sets to be considered to be matching. Specifically, in some implementations, even if all overlapping discrete data fields match, if the overlapping discrete data fields do not include a particular data field, the data sets are determined to be not matching. For example, if discrete data fields for price of electrical power obtained by the vehicle during the charging event and for geographic location at which the charging event took place are members of the overlapping discrete data fields and the values for those data fields match, but the total price of the electrical power obtained by the vehicle during charging is found in only one of the data sets, the data sets themselves may be determined to be not matching.

If it is determined at step 420 that the data sets received at step 400 and at step 410 are not matching, the process proceeds to step 430. At step 430, the process performs an information mismatch procedure. The information mismatch procedure may involve transmitting an error message indicating that the data pertaining to the charging event reported by the charging station does not match the data pertaining to the charging event reported by the telematics unit 114. In some implementations, the information mismatch procedure performed at step 430 may also involve additional operations. For example, upon determining that the data sets are not matching, the TSP may transmit, at step 430, a request to the telematics unit to determine whether there has been an equipment malfunction at the vehicle 102 and to transmit the results of such determination to the telematics unit 114. The request to determine whether or not there has been an equipment malfunction may include a request to perform a diagnostics test of all components of vehicle 102 that are involved in charging the vehicle 102 and monitoring the charging of the vehicle 102. In some implementations, step 430 may also involve transmitting an error message to the charging station or to an entity communicatively coupled to the charging station. In some implementations, an error message is sent to the charging station at step 430 only after first determining that there has not been an equipment malfunction at the vehicle.

On the other hand, if it is determined at step 420 that the data sets received at step 400 and 410 are matching, the process proceeds to step 440. At step 440, the process authorizes payment for the electrical power received by the vehicle 102 during the charging event. In some implementations, authorizing payment for electrical power involves transferring funds from an account linked to the telematics unit 114 or to the vehicle 102 to the charging station or to an entity associated with the charging station. Authorizing payment for the electrical power may also include but is not limited to assessing a charge to a subscriber account, transmitting a message to an institution that manages an account associated with the subscriber, and transmitting credit card information associated with the subscriber to the charging station or an entity associated with the charging station. One of ordinary skill in the art will understand that there are numerous other ways of authorizing payment for the electrical power received by the vehicle 102 during the charging event that are not specifically enumerated herein that may nevertheless be performed by implementations of the invention described herein.

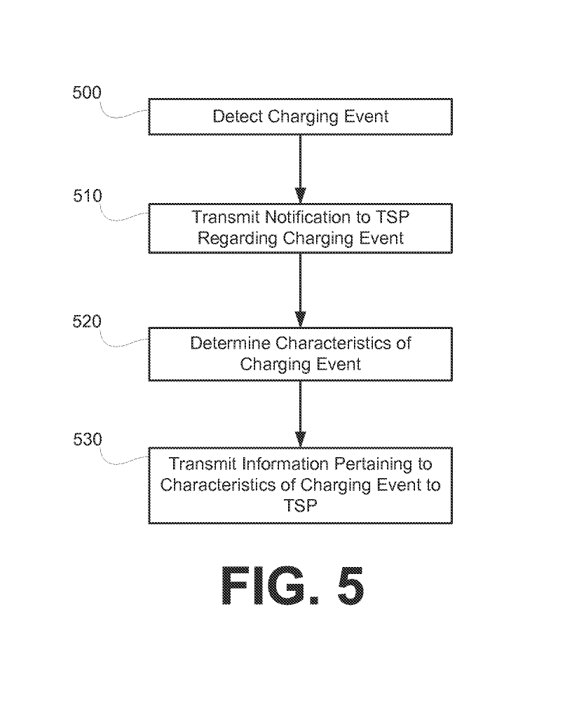

FIG. 5 is a flow chart summarizing an example process executed by a telematics unit for providing information pertaining to a charging event of an electric vehicle to a telematics service provider. At step 500, the telematics unit 114 of vehicle 102 detects that the vehicle is currently undergoing a charging event or is about to undergo a charging event. At step 510, the telematics unit 114 transmits a notification to a telematics service provider (TSP) that the vehicle is currently undergoing or is about to undergo a charging event. At step 520, the telematics unit 114 detects that the charging event has completed. The telematics unit 114 may also determine characteristics of the charging event at step 520. For example, the telematics unit 114 may determine the time at which the charging event began, the time at which the charging event ended, the amount of electrical power acquired during the charging event (e.g. in kWh), the price of the electrical power obtained by the vehicle during the charging event (e.g. in dollars/kWh), the total price of the electrical power obtained by the vehicle during the charging event (e.g. in dollars), the geographic location at which the charging event took place (e.g. as GPS coordinates), and an identifier for the charging station at which the charging event took place. The identifier for the charging station at which the charging event took place may be a name of the charging station, a charging station identification number, and an identification number indicating an owner of the charging station and an additional identification number assigned by the owner. At step 530, the charging station transmits the information pertaining to the characteristics of the charging event at step 520 to the TSP.

It will be appreciated by those of skill in the art that the execution of the various machine-implemented processes and steps described herein may occur via the computerized execution of computer-executable recommendations stored on a tangible computer-readable medium, e.g., RAM, ROM, PROM, volatile, nonvolatile, or other electronic memory mechanism. Thus, for example, the operations performed by the telematics unit may be carried out according to stored recommendations or applications installed on the telematics unit, and operation performed at the call center may be carried out according to stored recommendations or applications installed at the call center.

It is thus contemplated that other implementations of the invention may differ in detail from foregoing examples. As such, all references to the invention are intended to reference the particular example of the invention being discussed at that point in the description and are not intended to imply any limitation as to the scope of the invention more generally. All language of distinction and disparagement with respect to certain features is intended to indicate a lack of preference for those features, but not to exclude such from the scope of the invention entirely unless otherwise indicated.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method, implemented by a telematics service provider (TSP), for billing a subscriber of the TSP for electrical power received by a plug-in electric vehicle (PEV) during a charging event at a charging station, the method comprising:
receiving, at a computer readable medium, data pertaining to the charging event sent from a telematics unit of the PEV;
receiving data generated by the charging station and pertaining to the charging event;
determining that the data received from the telematics unit matches the data generated by the charging station; and
authorizing billing of the subscriber for the electrical power received during the charging event.

2. The method of claim 1, wherein the data received from the telematics unit comprises one or more data fields and the data generated by the charging station has one or more data fields; wherein each data field corresponds to an entry.

3. The method of claim 2, wherein the one or more data fields of the data received from the telematics unit include one of the group consisting of: the time at which the charging event began, the time at which the charging event ended, the amount of electrical power acquired during the charging event, the price of the electrical power obtained by the vehicle during the charging event, the total price of the electrical power obtained by the vehicle during the charging event, and the geographic location at which the charging event took place.

4. The method of claim 2, wherein the one or more data fields of the data generated by the charging station include one of the group consisting of: the time at which the charging event began, the time at which the charging event ended, the amount of electrical power acquired during the charging event, the price of the electrical power obtained by the vehicle during the charging event, the total price of the electrical power obtained by the vehicle during the charging event, the geographic location at which the charging event took place, and an identifier for the charging station at which the charging event took place.

5. The method of claim 2, wherein the determining that the data received from the telematics unit matches the data generated by the charging station comprises:
identifying one or more data fields that are included in both the data received from the telematics unit and the data generated by the charging station;
identifying, in the data received from the telematics unit, an entry corresponding to each of the identified data fields;
identifying, in the data generated by the charging station, an entry corresponding to each of the identified data fields;
determining, for each identified data field, that the corresponding entry in the data received from the telematics unit matches the corresponding entry in the data generated by the charging station.

6. The method of claim 1, wherein the authorizing billing of the subscriber includes one of the group consisting of: assessing a charge to a subscriber account, transmitting a message to an institution that manages an account associated with the subscriber, and transmitting credit card information associated with the subscriber to the charging station or an entity associated with the charging station.

7. The method of claim 1, the method further comprising:
determining that the vehicle is not registered to charge at the charging station; and
transmitting instructions to the telematics unit to prompt the user to register to charge at the charging station.

8. The method of claim 7, the method further comprising:
receiving data from the telematics unit indicating that the subscriber would like to register to charge at the charging station; and
authorizing billing of the subscriber for fees required to register with the charging station.

9. The method of claim 8, wherein the authorizing billing of the subscriber for fees required to register with the charging station includes one of the group consisting of:

10. A non-transient computer readable medium having stored thereon a set of computer executable instructions for billing a subscriber of a telematics service provider (TSP) for electrical power received by a plug-in electric vehicle (PEV) during a charging event at a charging station, the set of instructions comprising instructions for:
receiving, from a telematics unit of the PEV, data pertaining to the charging event;
receiving data generated by the charging station and pertaining to the charging event;
determining that the data received from the telematics unit matches the data generated by the charging station; and
authorizing billing of the subscriber for the electrical power received during the charging event.

11. The method of claim 10, wherein the data received from the telematics unit comprises one or more data fields and the data generated by the charging station has one or more data fields; wherein each data field corresponds to an entry.

12. The method of claim 11, wherein the one or more data fields of the data received from the telematics unit include one of the group consisting of: the time at which the charging event began, the time at which the charging event ended, the amount of electrical power acquired during the charging event, the price of the electrical power obtained by the vehicle during the charging event, the total price of the electrical power obtained by the vehicle during the charging event, and the geographic location at which the charging event took place.

13. The method of claim 11, wherein the one or more data fields of the data generated by the charging station include one of the group consisting of: the time at which the charging event began, the time at which the charging event ended, the amount of electrical power acquired during the charging event, the price of the electrical power obtained by the vehicle during the charging event, the total price of the electrical power obtained by the vehicle during the charging event, the geographic location at which the charging event took place, and an identifier for the charging station at which the charging event took place.

14. The method of claim 11, wherein the determining that the data received from the telematics unit matches the data generated by the charging station comprises:
identifying one or more data fields that are included in both the data received from the telematics unit and the data generated by the charging station;
identifying, in the data received from the telematics unit, an entry corresponding to each of the identified data fields;
identifying, in the data generated by the charging station, an entry corresponding to each of the identified data fields;
determining, for each identified data field, that the corresponding entry in the data received from the telematics unit matches the corresponding entry in the data generated by the charging station.

15. The method of claim 10, wherein the authorizing billing of the subscriber includes one of the group consisting of: assessing a charge to a subscriber account, transmitting a message to an institution that manages an account associated with the subscriber, and transmitting credit card information associated with the subscriber to the charging station or an entity associated with the charging station.

16. The method of claim 10, the method further comprising:
determining that the vehicle is not registered to charge at the charging station; and
transmitting instructions to the telematics unit to prompt the user to register to charge at the charging station.

17. The method of claim 16, the method further comprising:
receiving data from the telematics unit indicating that the subscriber would like to register to charge at the charging station; and
authorizing billing of the subscriber for fees required to register with the charging station.

18. The method of claim 17, wherein the authorizing billing of the subscriber for fees required to register with the charging station includes one of the group consisting of:

19. A system for billing a subscriber of a telematics service provider (TSP) for electrical power received by a plug-in electric vehicle (PEV) during a charging event at a charging station, the system comprising:
a server configured to receive, from a telematics unit of the PEV, data pertaining to the charging event, to receive, data generated by the charging station and pertaining to the charging event, to determine that the data received from the telematics unit matches the data generated by the charging station, and to authorize billing of the subscriber for the electrical power received during the charging event; and
the telematics unit, wherein the telematics unit is configured to transmit data pertaining to the charging event to the TSP.

20. The system of claim 19, the server further configured to determine that the vehicle is not registered to charge at the charging station, to transmit instructions to the telematics unit to prompt the user to register to charge at the charging station, to receive data from the telematics unit indicating that the subscriber would like to register to charge at the charging station, and to authorize billing of the subscriber for fees required to register with the charging station.
